(19) United States
(12) Patent Application Publication
(10) Pub. No.: US 2009/0289471 A1
(43) Pub. Date: Nov. 26, 2009

(54) Safety System

(76) Inventor: Ian Antony Finney, West Midlands (GB)

Correspondence Address: NIXON & VANDERHYE, PC, 901 NORTH GLEBE ROAD, 11TH FLOOR, ARLINGTON, VA, 22203, US

(21) Appl. No.: 12/373,581

(22) PCT Filed: Jul. 12, 2007
(86) PCT No.: PCT/GB2007/002593

§ 371 Date: Feb. 13, 2009

(30) Foreign Application Priority Data
Jul. 14, 2006 (GB) 0614014.9
Dec. 6, 2006 (GB) 0624336.4

(51) Int. Cl. B60R 21/013

(52) U.S. Cl. 296/187.04

(57) ABSTRACT

A safety system for a vehicle is incorporated within the structure of the vehicle. The system includes an energy absorbing structure which may collapse, crumple, deform or otherwise absorb energy under impact. A mounting arrangement moves the structure relative to the vehicle in the event that an imminent collision is sensed by a sensor. In one example, the structure is moved forward, relative to the vehicle, to leave a gap between the structure and hard components of the vehicle, such as the radiator, engine block or the like. This increase in distance results in a greater amount of energy being absorbed from the person, before the person can impact the hard components.

The present invention relates to safety systems for vehicles.

In recent years, various forms of legislation and regulation have been evolving to impose stricter requirements on motor vehicle design, particularly in relation to pedestrian safety. For example, pedestrian safety during collisions with the front of a vehicle is an area of concern.

One aspect of the present invention provides a safety system for a vehicle, comprising:

a mounting arrangement which, in use, mounts a mounted member on the vehicle, and

a sensor arrangement operable to sense an imminent collision,

the mounting arrangement being operable to move the mounted member to a position at which the danger of the imminent collision is reduced.

The system may further comprise a mounted member mounted by means of the mounting arrangement. The mounted member may be an energy absorbing structure which, in the event of a collision, is able to absorb energy from another body, in the event of a collision between the vehicle and the other body. The mounting arrangement may be operable, in the event of an imminent collision, to move the mounted member, relative to the vehicle or another part of the vehicle, to a position at which a greater amount of energy is absorbed from the other body, before the other body impacts the vehicle or the other part of the vehicle. The mounting arrangement may be operable, in the event of an imminent collision, to move the mounted member, relative to the vehicle or another part of the vehicle, to a position so chosen that the imminent collision will cause the other object to be deflected in a preferred direction relative to the vehicle. The chosen position of the mounted member may cause the other object to come to rest, relative to the vehicle, substantially at a predetermined position relative to the vehicle.

The mounting arrangement may be operable to increase the separation of the mounted member and another part of the vehicle, in the event of an imminent collision. The mounting arrangement may be operable to move another part of the vehicle away from the mounted member. The mounting arrangement may be operable to move the mounted member away from another part of the vehicle.

The mounting arrangement may move the mounted member forwards, upwards or downwards relative to the vehicle or the rest of the vehicle.

The sensor arrangement may be operable to detect the presence of an object with which a collision is imminent. The sensor arrangement may be operable to measure acceleration and/or deceleration for sensing an imminent collision. The sensor arrangement may be operable to detect one or more characteristics of an imminent collision, the mounting arrangement being operable to move the mounted member in a manner which depends on the detected characteristic or characteristics. Detected characteristics may include the size or height of an object, the human or non-human nature of the object, and the speed of collision.

Additional structures may be provided for deployment from a stored condition to an energy absorbing condition, in the event of an imminent collision. The additional structures may be selectively deployable, in accordance with a characteristic of an imminent collision. The additional energy absorbing structures may be cushion members which may be inflatable. The inflatable cushion members may expand in a direction generally opposite to the forward direction of the vehicle, when deployed. The inflatable cushion members may be inflatable over a bonnet panel of the vehicle.

The mounted member and/or the additional energy absorbing structures may provide at least one structure facing forward and/or sideways of the vehicle. The mounted member and/or the additional energy absorbing structures may provide at least one structure facing the expected point of initial impact from one or both sides, to restrict sideways deflection of the other object, relative to the vehicle. The mounted member and/or the additional energy absorbing structures may provide at least one structure facing the expected point of initial impact from one or both sides, to restrict sideways deflection of the other object, under the vehicle.

The mounting arrangement may provide resilient mounting of the mounted member, at least after being moved. The mounted member may be able to absorb energy by non-resilient deformation.

There may be a plurality of mounted members, as aforesaid. The mounted members may be mounted by a common mounting arrangement or by respective mounting arrangements.

The system may have at least one cushion member having a stowed condition and a deployed condition, and a container for the cushion member, when stowed,

the mounting arrangement being operable to move the container, relative to the vehicle, when deployment of the cushion member is required, to position the container adjacent a surface of the vehicle, to cause the cushion member to extend across the surface as it deploys.

The cushion member may have a relatively compact condition when stowed, and a relatively expanded condition when deployed.

The outer surface of the container, prior to deployment, may be generally continuous with the outer surface of the vehicle.

The mounting arrangement may move the container prior to deployment. Alternatively, the mounting arrangement may move a surface panel of the vehicle. The mounting arrangement may raise the container relative to the bonnet panel, prior to deployment. The container may be raised relative to the bonnet panel by lifting the container on the vehicle or alternatively by lowering an edge of the bonnet panel, or alternatively by tilting or swiveling the bonnet panel.

The mounting arrangement may position the or each cushion member for deployment in a direction generally opposite to the forward direction of the vehicle. The mounting arrangement may position the or each cushion member for deployment over a bonnet panel of the vehicle.

The container may be provided within a structure which is a passive impact absorption system. The cushion member may be an inflatable member, such as an airbag.

In another aspect, the invention provides a safety system for a vehicle, comprising:

at least one cushion member having a stowed condition and a deployed condition;

a container for the cushion member, when stowed;

a mounting arrangement which, in use, mounts the container on a vehicle;

a deployment arrangement which is operable to move the container, relative to the vehicle, when deployment of the cushion member is required, and to deploy the cushion member from the container;

the deployment arrangement being operable to position the container adjacent a surface of the vehicle, to cause the cushion member to extend across the surface as it deploys.

The cushion member may have a relatively compact condition when stowed, and a relatively expanded condition when deployed.

The deployment arrangement may include a sensor to sense a collision or imminent collision.

The outer surface of the container, prior to deployment, may be generally continuous with the outer surface of the vehicle.

The deployment arrangement may move the container prior to deployment. Alternatively, the deployment arrangement may move a surface panel of the vehicle. The deployment arrangement may raise the container relative to the bonnet panel, prior to deployment. The container may be raised relative to the bonnet panel by lifting the container on the vehicle or alternatively by lowering an edge of the bonnet panel, or alternatively by tilting or swiveling the bonnet panel.

The deployment arrangement may position the or each cushion member for deployment in a direction generally opposite to the forward direction of the vehicle. The deployment arrangement may position the or each cushion member for deployment over a bonnet panel of the vehicle. The deployed cushion member or members may channel the other body, in the event of a collision, substantially to a rest position, relative to the vehicle, at a predetermined position relative to the vehicle.

The container may be provided within a structure which is a passive impact absorption system. The cushion member may be an inflatable member, such as an airbag.

The invention also provides a safety system for a vehicle, comprising at least one member having a stowed condition and a deployed condition in the event of a collision with another object, the deployed condition serving to channel the other object to a rest position, relative to the vehicle, at a predetermined position relative to the vehicle.

Embodiments of the invention also provide a vehicle which includes a safety system of the type defined above. The pedestrian safety system may be mounted, prior to deployment, within the outer envelope of the vehicle.

Examples of the present invention will now be described in more detail, by way of example only, and with reference to the accompanying drawings, in which:

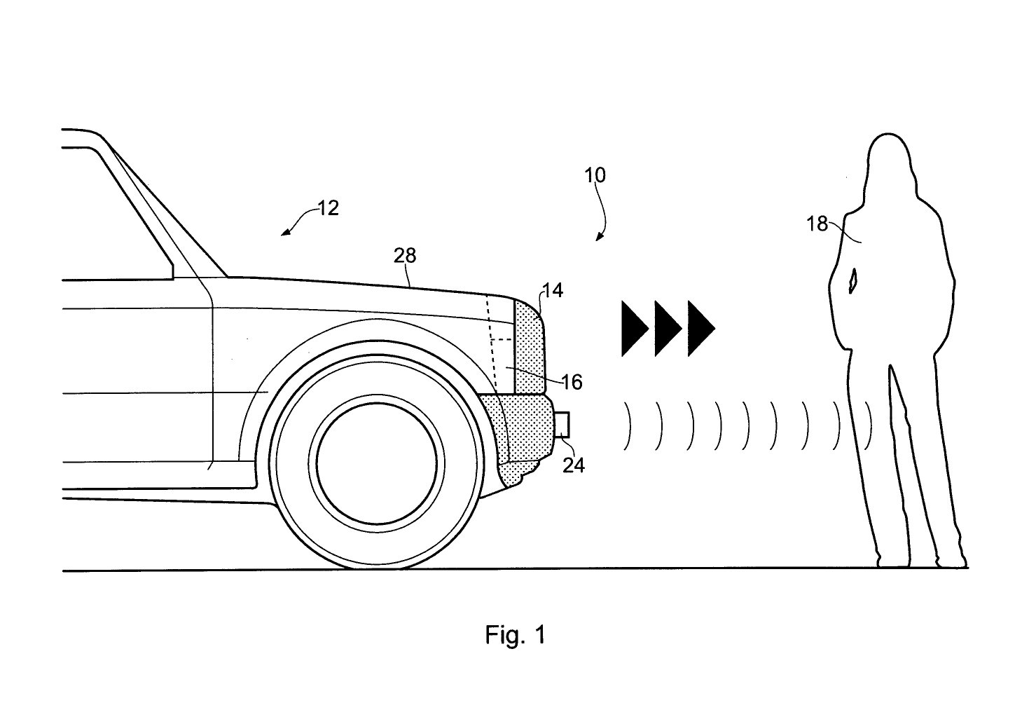

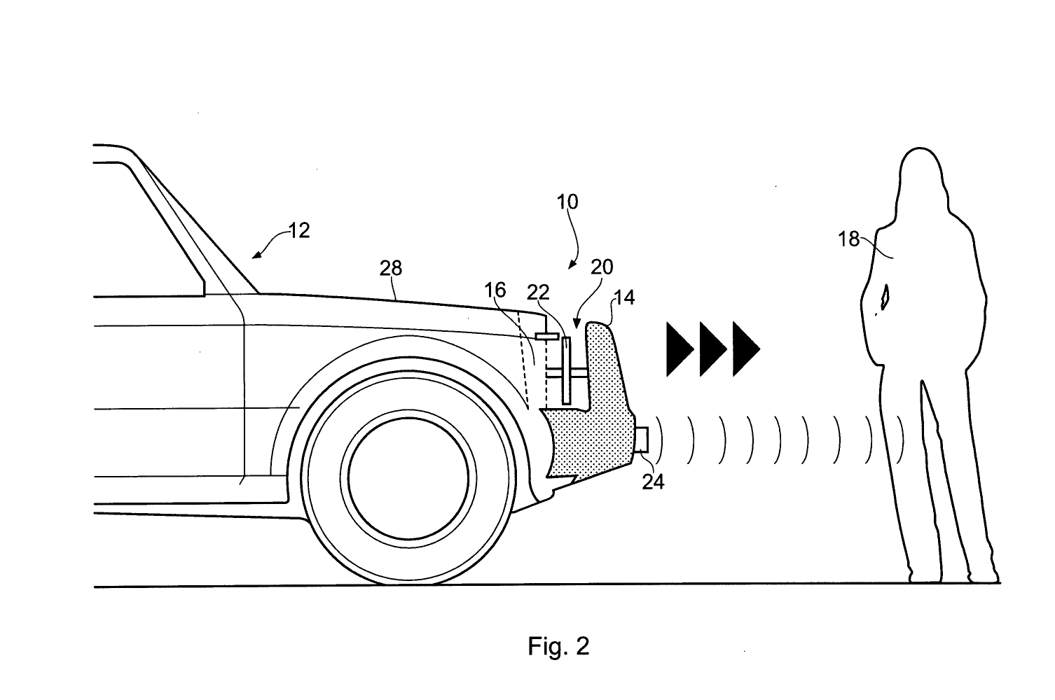

FIGS. 1 and 2 are side elevations of the front of a vehicle, showing a safety system prior to and during deployment;

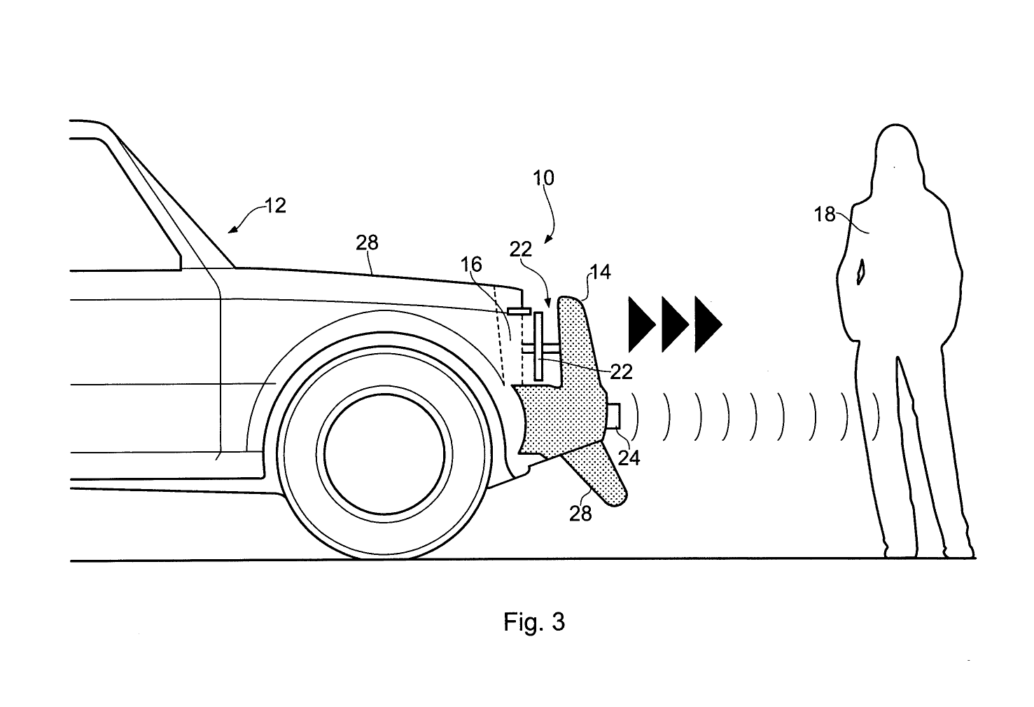

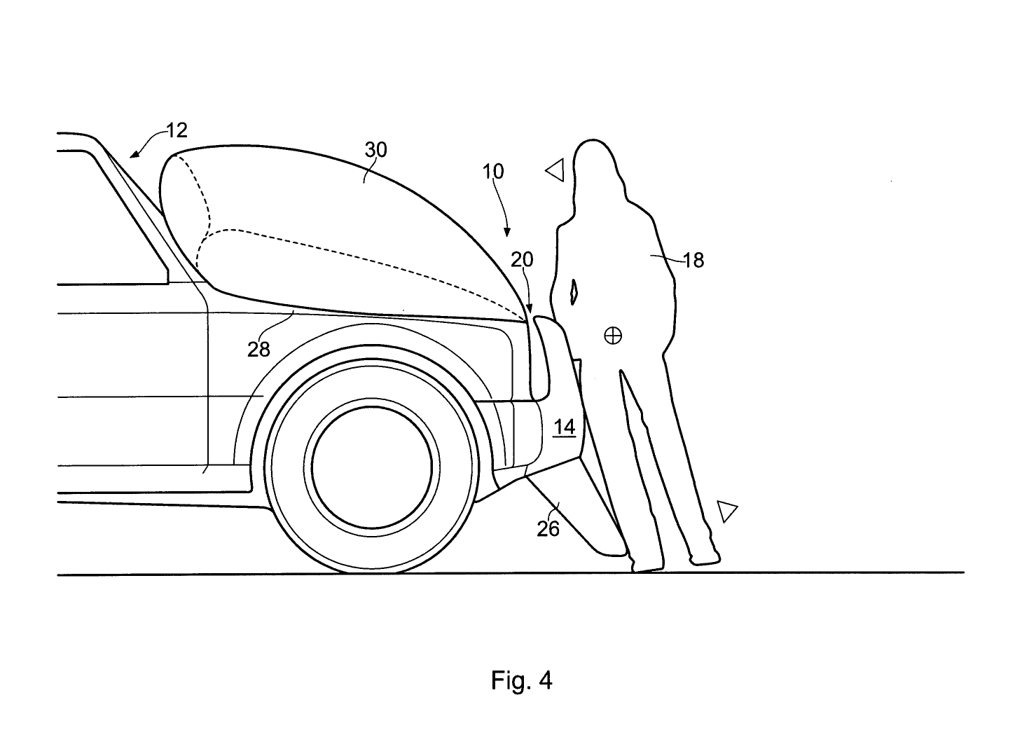

FIGS. 3 and 4 correspond with FIG. 2, showing alternative safety systems;

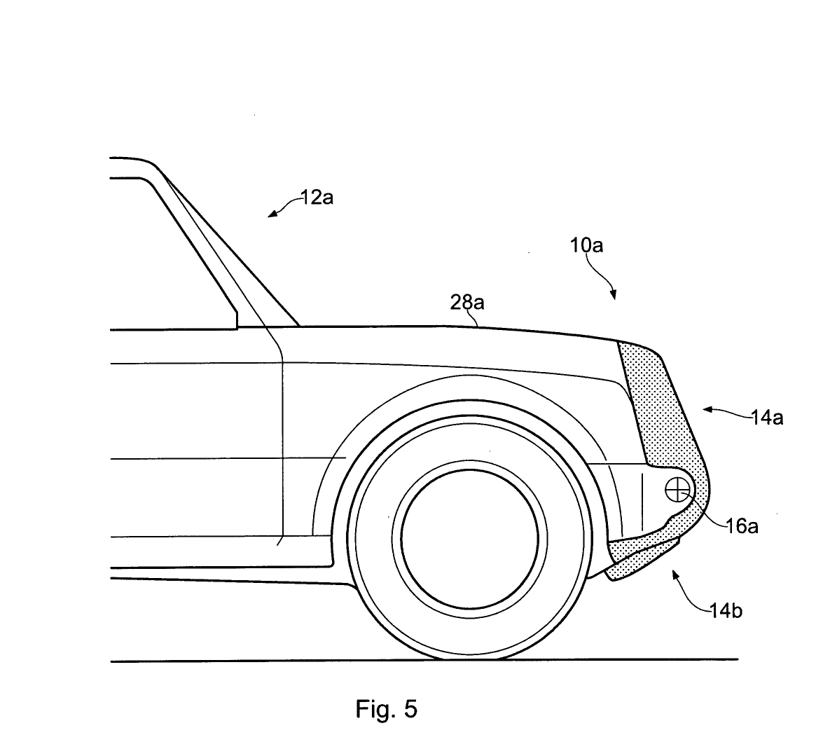

FIGS. 5, 6 and 7 correspond with FIGS. 1 and 2, illustrating an alternative safety system;

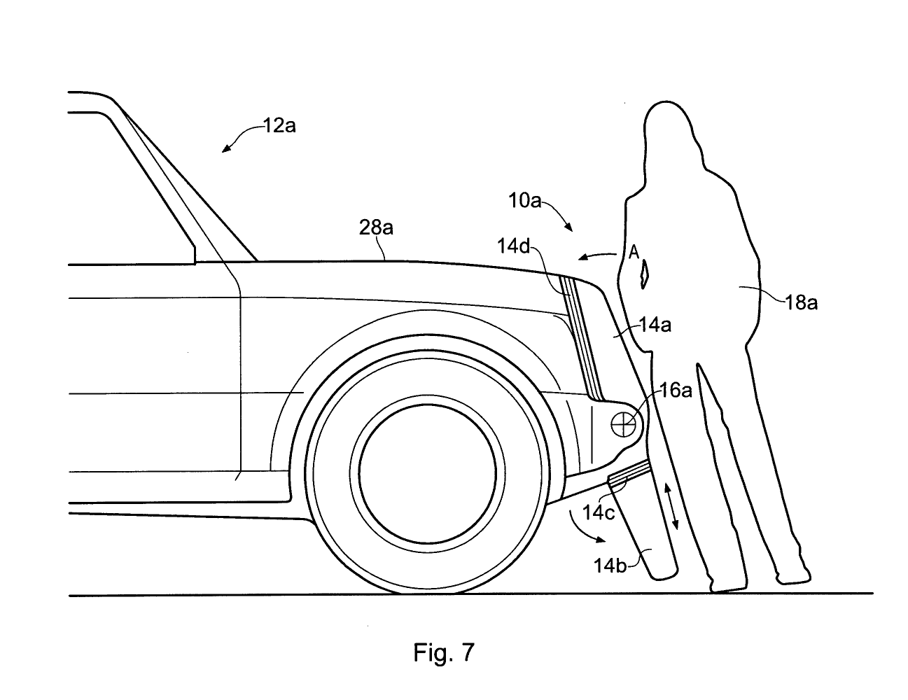

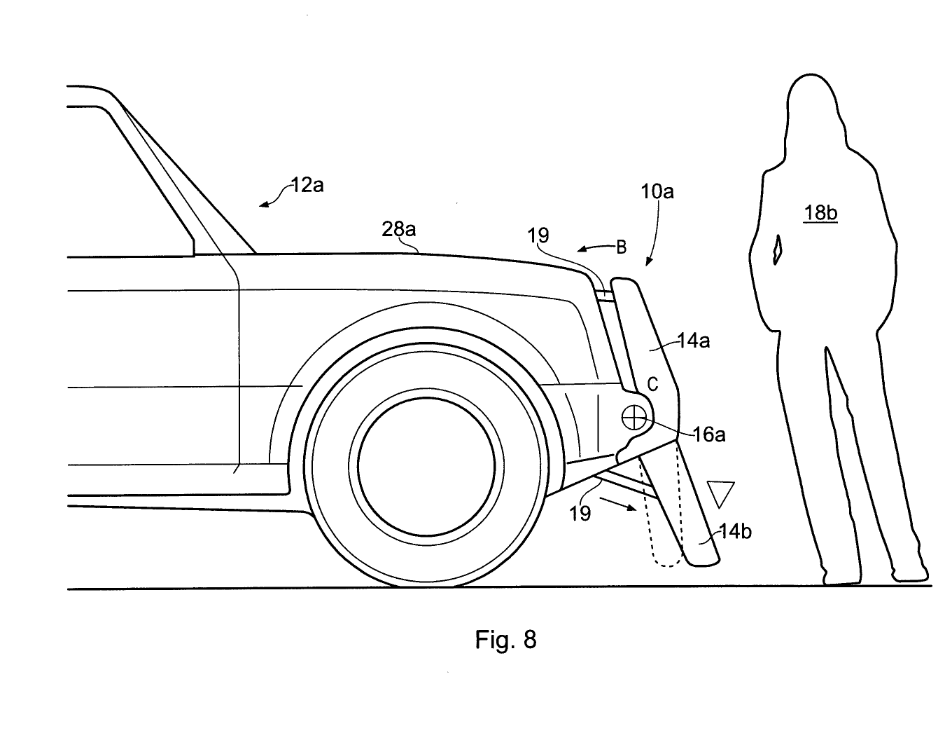

FIG. 8 corresponds with FIG. 7, illustrating an alternative mounting arrangement;

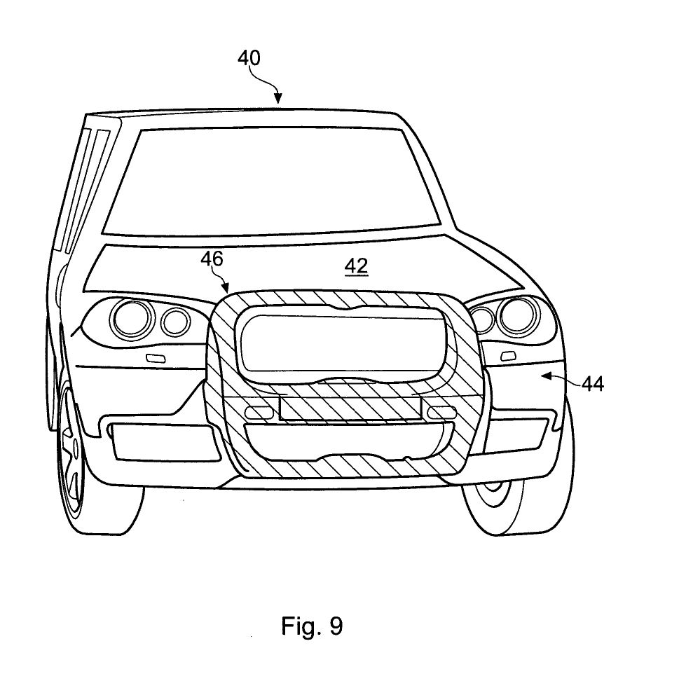

FIG. 9 is a perspective view of the front of a vehicle fitted with a further alternative safety system;

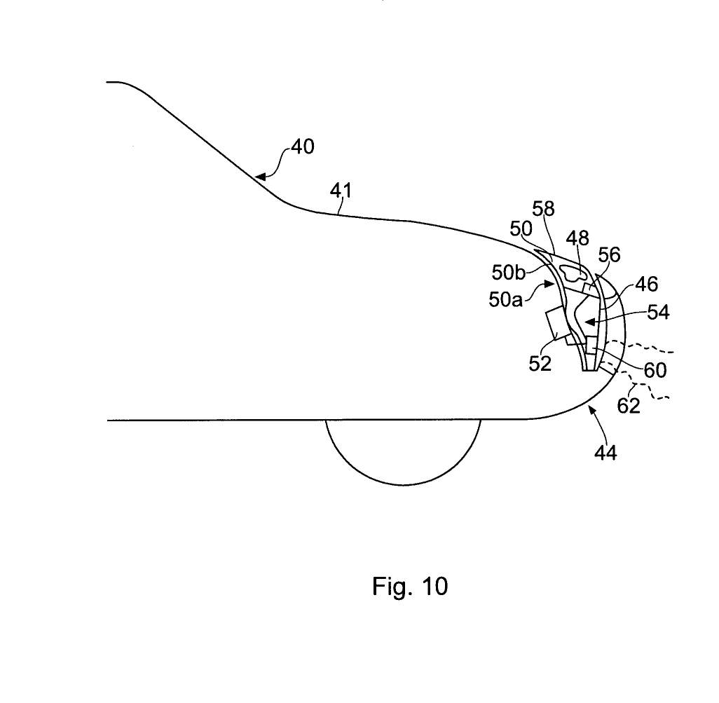

FIG. 10 is a fore and aft section through the vehicle of FIG. 9, with the system in the stowed condition;

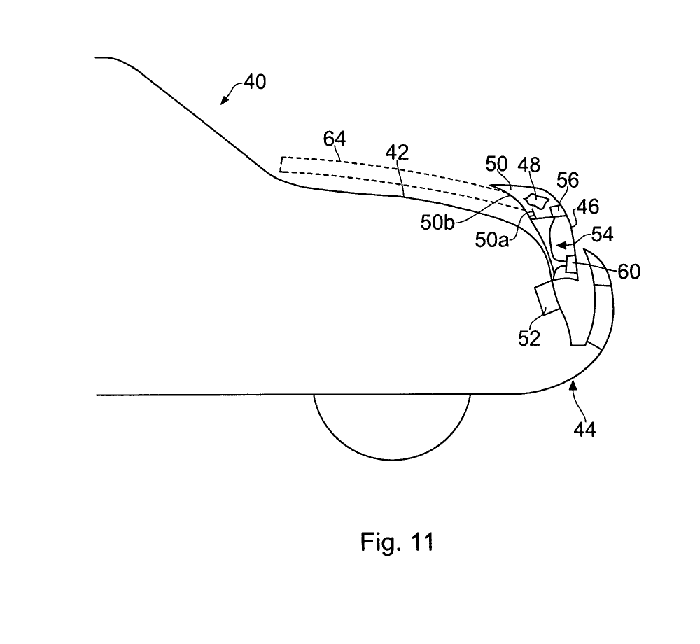

FIG. 11 corresponds with FIG. 10, showing the system in a raised position;

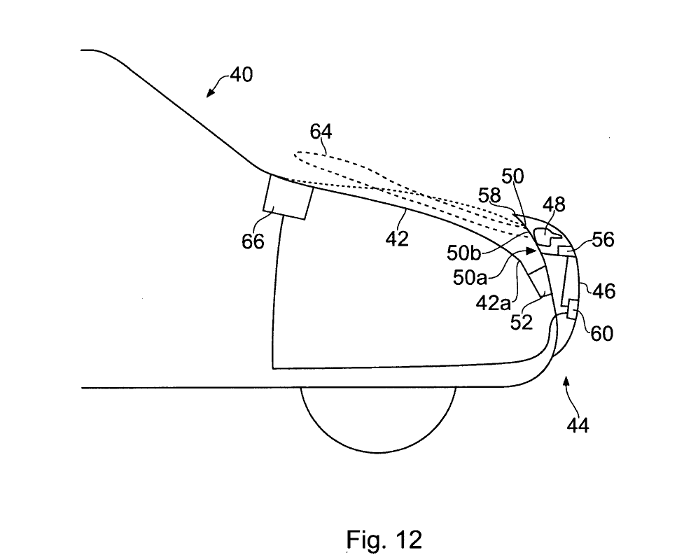

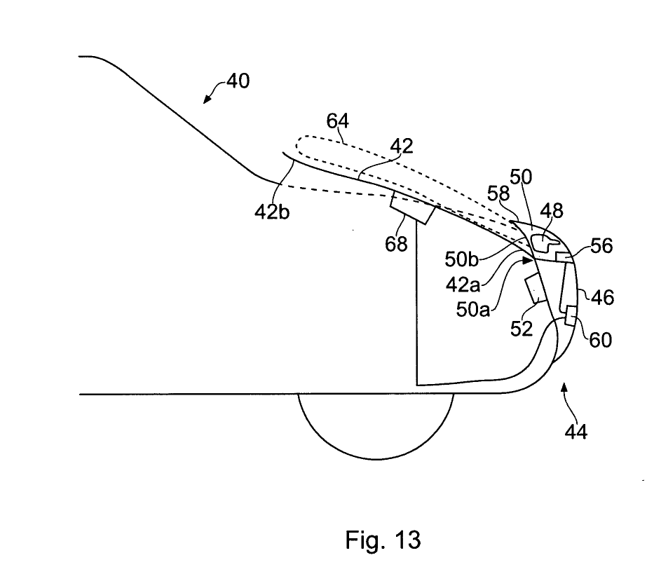

FIGS. 12 and 13 correspond with FIG. 10, showing the bonnet panel respectively lowered and tilted;

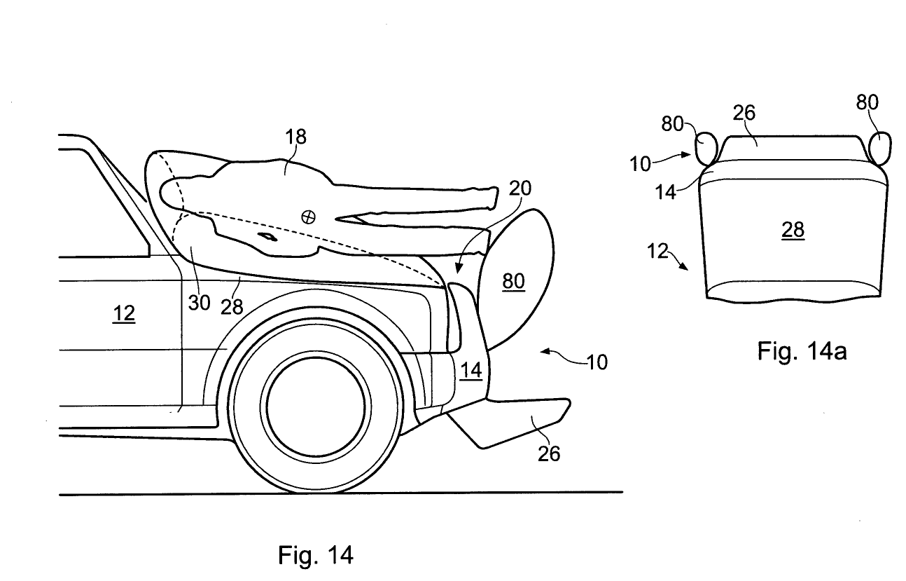

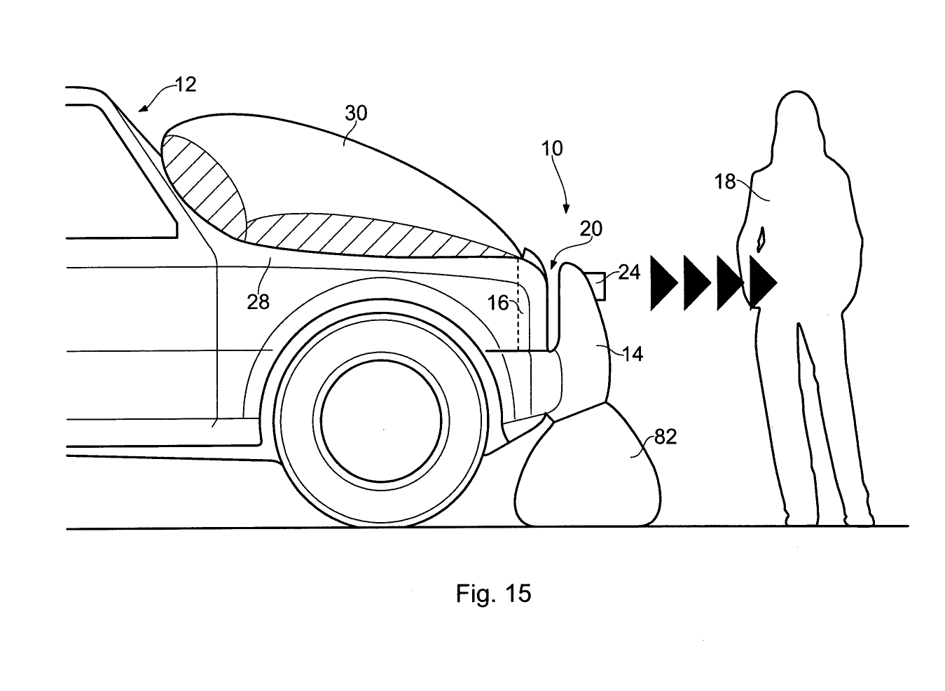

FIGS. 14 and 15 correspond with FIG. 2, showing further alternative systems, and FIG. 14a is a plan view of the system of FIG. 14, after deployment;

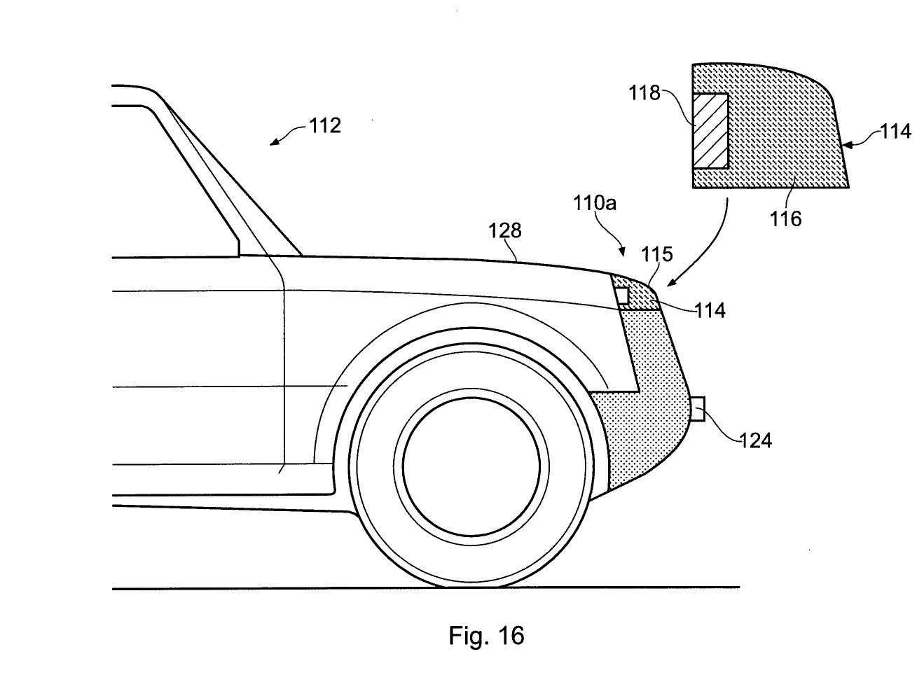

FIGS. 16 to 18 correspond with FIGS. 1 and 2, illustrating a further alternative safety system; and

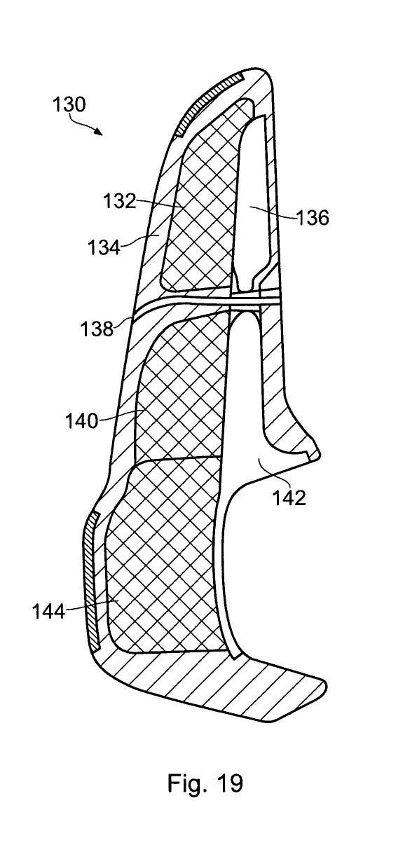

FIG. 19 is a vertical section through a safety system, with passive and active features.

FIG. 1 illustrates a safety system 10 for a vehicle 12. In this example, the system 10 is incorporated within the structure of the vehicle 12. The system, 10 includes a mounted member in the form of an energy absorbing structure 14, mounted by a mounting arrangement indicated generally at 16. The position of the energy absorbing structure 14, at the front of the vehicle 12, means that in the event of a collision between the vehicle 12 and another body, such as a person 18, the structure 14 will absorb energy from the collision. For example, the structure 14 may collapse, crumple, deform or otherwise absorb energy, such as by undergoing a non-resilient deformation.

However, the structure 14 is not fixed in position relative to the rest of the vehicle 12. This can be seen from FIG. 2. In the situation illustrated in FIG. 2, the event of an imminent collision with the person 18 has resulted in the mounting arrangement 16 moving the structure 14 relative to the vehicle 12. In this example, the structure 14 has moved forward, relative to the vehicle 12, leaving a gap 20 between the structure 14 and hard components 22 of the vehicle 12, such as the radiator, engine block or the like. Accordingly, the initial impact between the structure 14 and the person 18 takes place at a greater distance from the hard components 22, than would have been the case with the structure 14 in the position of FIG. 1, relative to the vehicle 12. By virtue of this greater distance, a greater amount of energy is absorbed from the person 18, before the person can impact the hard components 22.

Thus, the mounting arrangement has moved the mounted member to a position at which the danger of the imminent collision is reduced.

Accordingly, the impact can be expected to be less dangerous to the person 18, than would have been the case without movement of the structure 14 relative to the vehicle 12, and this improvement is provided without the front of the vehicle 12 being increased in size, during normal use.

Increasing the separation of the energy absorbing structure 14 and other parts of the vehicle, such as the hard components 22 may be achieved by moving the structure 14 forward relative to the vehicle 12, as has been described, but could be provided in other ways. For example, it may be possible to move other structures, such as the hard components 22, backwards relative to the vehicle 12, away from the structure 14, thereby increasing the separation of the energy absorbing structure 14 and the other parts 22.

Operation of the mounting arrangement 16 to move the structure 14 relative to the vehicle 12 may be initiated by a sensor arrangement 24, indicated schematically in FIGS. 1 and 2 and operable by any appropriate technology, such as reflected electromagnetic waves, light beams, ultrasonics or other sound waves, radar or the like. Thus, in this example, the sensors sense an imminent collision by detecting the presence of the person 18 or another object with which a collision is imminent. Alternatively, an imminent collision could be sensed by measuring acceleration and/or deceleration of the vehicle. (It is to be understood that no distinction is intended in this document between an acceleration with a negative value, and a deceleration).

The mounting arrangement 16 is arranged to provide resilient mounting of the structure 14, at least after moving to the position shown in FIG. 2, relative to the vehicle 12. This may be provided by means of gas springs, gas struts, damper components, or the like.

In this example, the structure 14 moves forwards relative to the vehicle 12, to the position of FIG. 2, but could alternatively move upwards or downwards relative to the vehicle 12. In particular, a tall vehicle, or a vehicle with large clearance underneath, may use a structure 14 which is moved downwards, to reduce the risk of a person 18 from passing beneath the vehicle.

In another example, the sensors 24 may assess the imminent collision to detect one or more characteristics of the collision. For example, they may detect the size of the person (adult or child). This information may be used to operate the mounting arrangement 16 to move the structure 14 in a manner which depends on the detected characteristics. For example, in the event that the person 18 is detected to be a child, the structure 14 may be moved down to an impact height which is safer for a child, or be moved to an alternative height safer for a collision with an adult, in the event that the person 18 is assessed as being of adult stature. Other characteristics which might be detected include the size of the person 18 or other object, the human or non-human nature of the object and the speed of collision.

FIG. 3 shows an example of an arrangement in which additional energy absorbing structures are provided for deployment from a stored condition to an energy absorbing condition, in the event of an imminent collision. For example, comparison of FIG. 3 with FIG. 1 reveals that a downwardly extending portion 26 of the structure 14 has extended from a previously stowed condition (in which the portion 26 is not visible in FIGS. 1 and 2). The downward extension of the portion 26 helps resist the person 18 passing below the vehicle 12. The inclined angle of the portion 26 helps increase the tendency of the structure 14 to deflect the person 18 upwards, over the bonnet 28 of the vehicle, which will generally be safer for the person 18 than passing beneath the vehicle 12.

FIG. 4 illustrates a further example of additional energy absorbing structures deployed in the event of an imminent collision. In this example, in addition to movement of the structure 14 and deployment of a portion 26, an airbag 30 has been inflated from a previously stored condition within the structure 14, to extend over the bonnet 28. Accordingly, a person 18 passing over the structure 14 toward the bonnet 28 is cushioned by the airbag 30. The initial containment of the airbag 30 within the structure 14, prior to inflation, results in the airbag 30 expanding over the bonnet 28 in a direction generally opposite to the forwards direction of the vehicle 12, so that danger to the person 18, arising from explosive expansion of the airbag 30 in the forward direction, is reduced.

FIG. 5 illustrates a safety system 10a for a vehicle 12a. In this example, the system 10a is incorporated within the structure of the vehicle 12a. The system 10a includes two mounted members 14a, 14b, both in the form of energy absorbing structures, mounted by a mounting arrangement indicated generally by a pivot axis (or axes) 16a. The position of the energy absorbing structure 14a, at the front of the vehicle 12a, means that in the event of a collision between the vehicle and another body, such as a person 18a (FIG. 7), the structure 14a will absorb energy from the collision. For example, the structure 14a may collapse, crumple, deform or otherwise absorb energy, such as by undergoing a non-resilient deformation. The structure 14a may be arranged so that it can be restored to its original condition by mechanical or manual intervention.

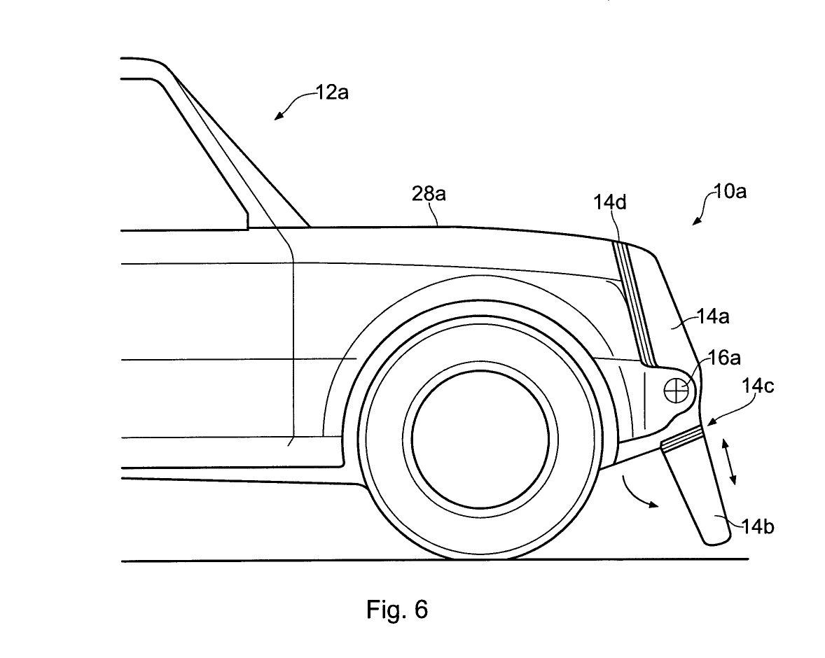

In the event of an imminent collision, sensed by a sensor arrangement of the type described above (and not illustrated in FIG. 5), the mounted member 14b is deployed from a previously stowed position (FIG. 5) to the extended position illustrated in FIGS. 6 and 7. The member 14b may be similar in form and function to the portion 26 of FIG. 3. In particular, the deployed position of the member 14b helps resist the person 18a passing below the vehicle 12a. The inclined angle of the member 14b helps increase the tendency for the person 18a to be deflected upwards, over the bonnet 28a, which will generally be safer for the person 18a, than passing beneath the vehicle 12a. An airbag may be deployed over the bonnet 28a, as described above.

In addition to rotation of the member 14b about the axis 16a (or another axis spaced from the axis 16a), the member 14b may be moved radially relative to the axis 16a, so that ground clearance below the member 14b can be maintained over a range of angles about the axis 16a. Movement of the member 14b may be provided by means of gas springs, gas struts, damper components or mechanical actuators and the member 14b is arranged, in this example, to be resiliently mounted, at least after moving to the position shown in FIG. 6. A flexible bellows arrangement 14c may be provided to allow radial movement of the member 14b, without exposing working components of the mounting arrangement 16a.

In similar manner, a bellows arrangement 14d may cover components of the mounting arrangement 16a, for mounting the member 14a. These may include actuators which allow the member 14a to tilt forward or backward about the axis 16a, and may include resilient mountings such as gas springs, gas struts, damper components, mechanical springs or the like, to provide resilient mounting of the structure 14a, at least in the position illustrated in FIG. 6. Thus, the inventors envisage that appropriate responses to an imminent collision could include (1) tilting the member 14a back to reduce the angle and cause a pedestrian to be deflected in the preferred direction onto the bonnet 28a, or (2) to tilt forward to increase the separation of the member 14a, from other components of the vehicle, such as an engine, so that a greater amount of energy is absorbed before impact with those other components.

The moment of impact with a pedestrian 18a is illustrated in FIG. 7. It can be seen from this drawing that the risk of the pedestrian 18a passing under the vehicle 12a is low, that the inclination of the members 14a, 14b will tend to deflect the pedestrian 18a onto the bonnet 28a, and that the impact absorbing nature of the members 14a, 14b and/or their resilient mountings will further increase the safety of the pedestrian 18a.

FIG. 8 illustrates a modified version of the arrangement of FIGS. 5 to 7, shortly before impact with a pedestrian 18b. In this example, the members 14a, 14b are movable around the axis 16a by actuators 19 which may be in the form of mechanical actuators (such as rack and pinion mechanisms) and which include shock absorber mechanisms such as gas springs, gas struts, gas or mechanical damper components, or the like. The actuators 19 are able to extend or retract to vary the angle of the members 14a, 14b at the time of impact, for reasons explained above.

Further examples of arrangements having airbags deployable in conjunction with moving structures can now be described, with particular reference to FIGS. 9 to 15.

FIG. 9 illustrates the front of a vehicle 40. In this example, the vehicle is a relatively large vehicle of the type commonly known as a 4×4, off-road or sports utility vehicle (SUV). The vehicle engine (not shown) is mounted under a bonnet 42 at the front of the vehicle 40 (with all directions being related to the normal direction of motion of the vehicle). The front of the vehicle 44 and the bonnet 42 represent likely locations for impact with a pedestrian, during a collision. Accordingly, the vehicle 40 is fitted with a pedestrian safety system indicated generally at 46 (by shading) and illustrated in more detail in FIG. 10. The safety system 46 is shaded in FIG. 9.

The system 46 includes a cushion member 48 in a container 50. The container has a mouth 50a covered by a membrane 50b. The container 50 is mounted on the vehicle by a mounting arrangement indicated generally at 52 and to be described more fully below. The system 46 also incorporates a deployment arrangement 54, for the cushion member 48, to be described further below.

In this example, the cushion member is an inflatable member, preferably an inflatable airbag having an associated trigger arrangement 56, including a gas cylinder (forming part of the trigger 56) for inflating the airbag 48. Accordingly, when triggered and inflated, the airbag 48 will expand from a relatively compact condition when stowed within the container 50, as illustrated in FIG. 10, to a relatively expanded condition when deployed, as will be described.

The mounting arrangement 52 for the system 46 is illustrated schematically in FIG. 10. In this example, the mounting arrangement includes a drive mechanism which allows the system 46 to be lifted on the vehicle 40 from the position illustrated in FIG. 10, to the raised position illustrated in FIG. 11. This movement is provided when deployment of the cushion member 48 is required, as will be described.

In the lower position illustrated in FIG. 10, it can be seen that the upper surface 58 of the container 50 is generally continuous with the outer surface of the vehicle 40, particularly the upper surface of the bonnet 42. This places the system within the outer envelope of the vehicle, prior to deployment. This is considered to improve the aesthetics of the vehicle 40, during normal use, prior to deployment of the system 46, because the presence of the system is not apparent to the observer.

In an alternative arrangement, the system 46 may be mounted to the front of the vehicle. This places the system outside the envelope of the base vehicle, leaving the system visible even prior to deployment. In this alternative, the aesthetics may be improved by merging the external shape of the system with the exterior envelope of the base vehicle.

A sensor 60 is incorporated within the system 46, as part of the deployment arrangement 54. The sensor may be a forward-looking device which monitors a region 62 to detect objects in front of the vehicle 40 and to calculate when a collision is expected. It is envisaged that sensor systems 60 may be sufficiently intelligent to identify a pedestrian prior to an impact, and to deploy the system 46 only when a collision or imminent collision with a pedestrian is detected.

In the embodiment illustrated in FIGS. 10 and 11, when the sensor 60 determines that a pedestrian collision is imminent, the deployment arrangement 54 activates the drive mechanism of the mounting arrangement 52 to raise the container 50 relative to the bonnet 42, by lifting the container 50 on the vehicle. This moves the container out of the envelope of the vehicle and places the container mouth 50a just above the bonnet 42, at the front edge of the bonnet, as can be seen from FIG. 11. The trigger arrangement 56 is then activated to inflate the airbag 48, which will expand out of the container 50, bursting the membrane 50b and deploying in a direction generally opposite to the forward direction of the vehicle, until extending across the surface of the bonnet 42. The final, deployed condition of the airbag 48 is indicated by broken lines 64 in FIG. 11.

In another example, illustrated in FIG. 12, an alternative drive mechanism 66 is used as part of the deployment arrangement. The mechanism 66 is incorporated with the hinges of the bonnet and serves to lower the front edge 42a of the bonnet from the original position (dotted lines) to the final position (solid line). This is done prior to deployment, thereby leaving the container 50 above the front edge 42a. Again, the airbag 48 can then deploy over the bonnet 42, in a direction generally opposite to the forward direction of the vehicle, to the deployed state indicated by chain-dotted line 64.

In a further example, illustrated in FIG. 13, a drive mechanism 68 may be provided mid-way across the bonnet panel 42, allowing the panel 42 to be swiveled so that the rear edge 42b rises and the front edge 42a is lowered from the original position (broken line) to the position indicated by the solid line. Again, this leaves the container 50 above the front edge 42a, so that the airbag 48 can expand to deploy over the bonnet panel 42, in a direction opposite to the forward direction of the vehicle. The deployed condition is indicated at 64.

It will be appreciated by the skilled reader that the mechanism 68 must be disengaged if the bonnet is to be opened for normal maintenance, to allow the bonnet panel 42 to hinge open about its rear edge.

In each of the examples illustrated in FIGS. 11, 12 and 13, the airbag 48 is deployed, preferably in advance of the collision, when an imminent collision is sensed. The airbag 48 is deployed in a rearward direction, so that the expanding airbag 48 does not expand toward the pedestrian, which could have the effect of further increasing the force of collision.

The possibility of early deployment depends on the nature of the sensor 60 and any actuators required, particularly depending on their speed of response. The examples which have been described are active systems, in the sense that the configuration of the vehicle 40 is altered when a collision is imminent, placing the vehicle in a condition which is safer for the pedestrian. For example, a pedestrian being thrown onto the bonnet 42 is cushioned by the deployed airbags 48.

Any active system may suffer from faults and thus fail to activate when required. Accordingly, the system 46 may be embodied as a structure which is a passive impact absorption system such as those described in our co-pending European Patent Application EP 1580087 A, or previous British Patent GB 2338687 B, or GB 2327912 B, so that even in the event of the system 46 failing to deploy in the manner described, greater pedestrian safety will be provided than would be the case if the impact was with the base vehicle 40, in the absence of the system 46. Furthermore, it is envisaged that appropriate design may allow the airbag to be usefully deployed even if the system fails to move to its correct deployment position relative to the vehicle. For example, deployment of the airbag from the position shown in FIG. 10, without movement of the container to the position of FIG. 11, may result in the airbag being deployed between the bonnet panel and the engine block of the vehicle, providing some improvement in safety.

Turning now to FIG. 14, there is shown a modified version of the arrangement of FIG. 4, after an impact with a person 18, who has ridden up over the structure 14 onto the deployed airbag 30, over the bonnet 28. In this example, movement of the structure 14, particularly the deployment of a portion 26, is chosen so that the imminent collision causes the person 18 to be deflected in a preferred direction relative to the vehicle 12, in this case up onto the bonnet 28. This preferred movement is further encouraged by the provision of at least one structure 80 facing sideways of the vehicle. In this example, the sideways structure 80 is a further airbag, initially accommodated in a corner region of the vehicle in order to deploy forwardly, alongside the person 18. This tends to guide the person 18 to a central position over the bonnet 28, rather than allowing the person 18 to fall off the side of the vehicle to land on the ground. There may be sideways structures 18 at both front corners of the vehicle 12 (see FIG. 14a), so that in the example of FIG. 14, the pedestrian 18 is channeled up by the portion 26 and centrally by the sideways structures 80, to land on the airbag 30. This results in the final impact and rest position being more predictable, with improved safety expected to result.

In particular, it can be shown that, when a pedestrian stays with the vehicle after impact, the forces experienced by the pedestrian are independent of the mass of the vehicle. Thus, by retaining the pedestrian on the vehicle, the collision forces become substantially the same, for any size of vehicle. In addition, the risk of the pedestrian being run over by the vehicle, after the collision, is removed.

FIG. 15 indicates a further example in which the downward portion 26 is replaced with a downwardly deploying airbag 82 to restrict deflection of the pedestrian 18 under the vehicle 12.

Sideways facing structures 80 could be provided at various different heights and could be selectively activated, according to characteristics of the imminent collision, particularly height and size of an object such as a pedestrian 18.

FIGS. 16 to 18 illustrate a further example which has some similarities with the arrangement of FIGS. 1 and 2.

In this example, the vehicle 112 is provided with a safety system 110 including a mounted member 114 in the form of an energy absorbing structure. The structure 114 provides the leading edge 115 of the vehicle bonnet 128. The inset drawing to FIG. 16 is an enlarged cross-section of the structure 114, showing an internal energy absorbing body 116, such as an energy absorbing foam. An airbag 118 is stowed within the structure 114, behind the body 116.

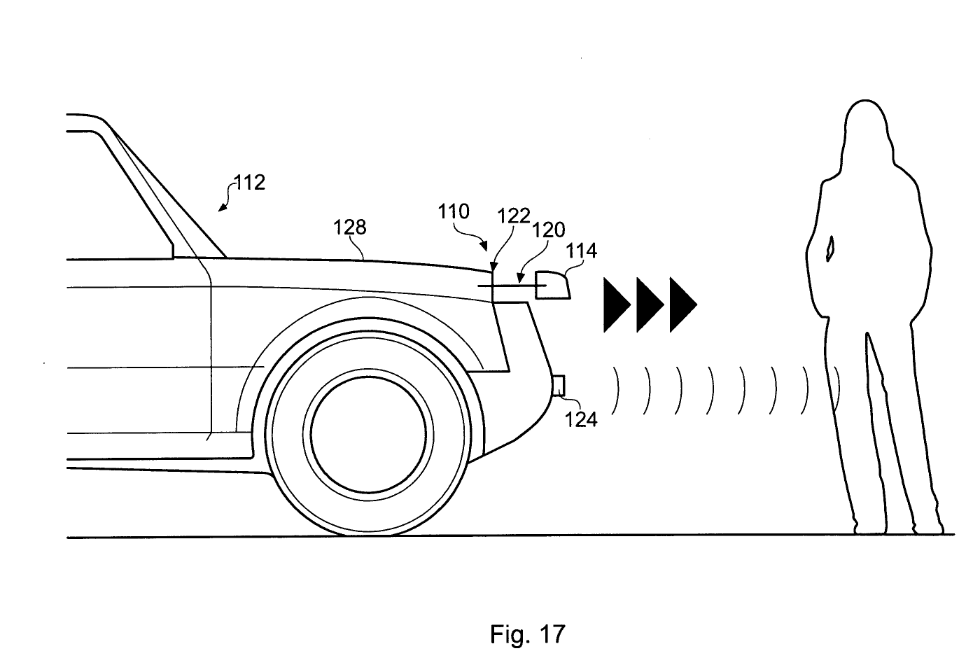

Sensors 124 are provided to detect an imminent collision, as described above. In the event that an imminent collision is detected, the structure 114 is moved to a position at which the danger of the imminent collision is reduced. This is achieved by a mounting illustrated in FIG. 17 and in the form of an actuator 120, such as a gas strut or other fast-acting mechanism, which can advance the structure 114, as illustrated in FIG. 17.

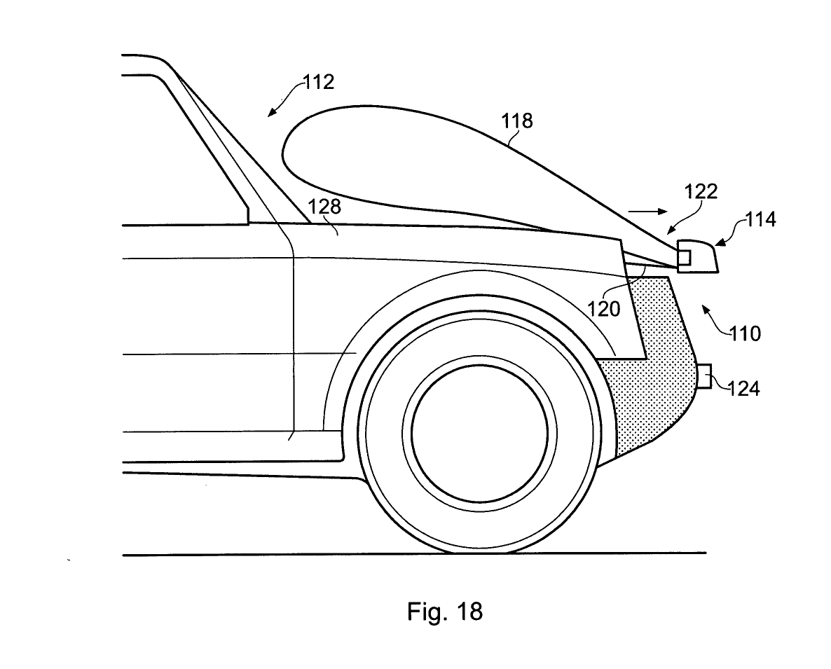

Movement to the position of FIG. 17 achieves two effects. First, a greater amount of energy can be absorbed before a pedestrian or other body impacts the base vehicle (particularly hard objects such as engine blocks etc.), because the separation of the body 114 from the rest of the vehicle has been increased. Secondly, as can readily be understood from comparison of FIG. 17 with the inset drawing of FIG. 16, the forward movement of the structure 114 provides a gap 122, behind the structure 114, allowing the airbag 118 to be deployed over the bonnet 128, as illustrated in FIG. 18.

In this example, the size of the structure which is moved (the structure 114) is much smaller than in some of the other examples and, being built primarily of energy absorbing foam or similar material, may be significantly lighter than other examples. Accordingly, it is envisaged that inertia, weight and speed of actuation will be more readily dealt with, during design.

FIG. 19 is a section through a safety system 130, which has various active and passive features and can be mounted as a separate unit (such as a retro-fitted unit) to the front of a base vehicle.

Toward the top of the system 130, there is a body 132 of energy absorbing foam within an outer skin 134, which may be polyurethane. The combination of the body 132 and outer skin 134 can be designed primarily to meet requirements for head impact with a pedestrian, being the most likely impact to occur at that height on the vehicle.

Behind the body 132, an airbag 136 may be mounted, for rearward deployment in the manner which has been described above in relation to several embodiments.

These upper features of the system 130 correspond with the features of the structure 114 of FIG. 16. They may form a unit which is initially integral with the rest of the system 130, but severable at a line 138, in the event of an imminent collision, so that the body 132 can move to an improved position prior to collision, and the airbag 136 can more readily be deployed.

Below the severance line 138, the system 130 has a second body 140 of energy absorbing foam, supported by an armature or other reinforcement 142 for increased support and rigidity, providing a performance designed to meet requirements for pelvic or abdominal impact.

Toward the lowermost extremity of the system 130, a further body of energy absorbing material 144 is provided, of suitable size and location to address requirements for leg impact during a collision.

Accordingly, the system 130 has different regions tailored to meet various different requirements on collision performance, each located at the appropriate position and tailored to the relevant requirement.

The system may be mounted so that the whole or any part of the system can be moved, pivoted, slid, tilted or otherwise deployed in the event that an imminent collision is sensed.

Many variations and modifications can be made to the arrangements described above, without departing from the scope of the invention. For example, various combinations of the energy absorbing structures and additional energy absorbing structures could be used. It is envisaged that by providing adequate sensor technology and appropriately fast processing power, a choice of response can be made, in accordance with characteristics of the imminent collision. For example, the energy absorbing structure 14 can be moved forward, up or down by an amount which depends on the speed of the collision, the size of the person 18 etc. Additional airbags 30, 82 or sideways structures 80, or a portion 26 can be selectively deployed in accordance with the detected characteristics of the imminent collision, in order to improve the safety of the person 18. For example, the selected structures may guide them to be deflected in the preferred direction relative to the vehicle 12, such as onto a deployed airbag.

It is further envisaged, as noted above, that characteristics of an imminent collision may be assessed, and that a structure may be moved to a different height. This is envisaged to improve safety in pedestrian collisions. In addition, occupant safety in vehicle-to-vehicle collisions may be improved. For example, a relatively tall, conventional vehicle may impact a relatively short, conventional vehicle above the strongest structures of the short vehicle (typically the chassis or sill height). Moving a structure in the manner described above may be used to change the impact height. Adjusting the impact height, preferably to the height of the strongest structures such as the chassis or sill, is expected to reduce the risk of collision damage to the integrity of the passenger compartment, thereby improving occupant safety. It is envisaged that a standard could be created for the height of impacts, so that each vehicle design can be optimised for collisions at that height, if necessary by moving structures to that height, when a collision is imminent.

Examples described above have included airbags and like arrangements, particularly for pedestrian protection. If an imminent collision is assessed as being vehicle-to-vehicle, the system may dispense with triggering airbags to inflate. Alternatively, if airbags are sufficiently robust, they may be used to change the height of an imminent collision, for reasons noted above.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A safety system for a vehicle, comprising:
a mounting arrangement which, in use, mounts a mounted member on the vehicle, and
a sensor arrangement operable to sense an imminent collision,
the mounting arrangement being operable to move the mounted member to a position at which the danger of the imminent collision is reduced.

2. (canceled)

3. A system as claimed in claim 1, further comprising a mounted member, wherein the mounted member is an energy absorbing structure which is able to absorb energy from another body, in the event of a collision between the vehicle and the other body.

4. A system as claimed in claim 1, wherein the mounting arrangement is operable, in the event of an imminent collision, to move the mounted member, relative to the vehicle or another part of the vehicle, to a position at which a greater amount of energy is absorbed from the other body, before the other body impacts the vehicle or the other part of the vehicle.

5. A system as claimed in claim 1, wherein the mounting arrangement is operable, in the event of an imminent collision, to move the mounted member, relative to the vehicle or another part of the vehicle, to a position so chosen that the imminent collision will cause the other object to be deflected in a preferred direction relative to the vehicle.

6. A system as claimed in claim 5, wherein the chosen position of the mounted member causes the other object to come to rest, relative to the vehicle, substantially at a predetermined position relative to the vehicle.

7. A system as claimed in claim 1, wherein the mounting arrangement is operable to increase the separation of the mounted member and another part of the vehicle, in the event of an imminent collision.

8-10. (canceled)

11. A system as claimed in claim 1, wherein the sensor arrangement is operable to detect the presence of an object with which a collision is imminent.

12. A system as claimed in claim 1, wherein the sensor arrangement is operable to measure acceleration and/or deceleration for sensing an imminent collision.

13. A system as claimed in claim 1, wherein the sensor arrangement is operable to detect one or more characteristics of an imminent collision, the mounting arrangement being operable to move the mounted member in a manner which depends on the detected characteristic or characteristics.

14. (canceled)

15. A system as claimed in claim 1, wherein additional structures are provided for deployment from a stored condition to an energy absorbing condition, in the event of an imminent collision.

16. A system as claimed in claim 15, wherein the additional structures are selectively deployable, in accordance with a characteristic of an imminent collision.

17. A system as claimed in claim 15, wherein the additional energy absorbing structures are cushion members.

18. A system as claimed in claim 17, wherein the cushion members are inflatable.

19. A system as claimed in claim 18, wherein the inflatable cushion members expand in a direction generally opposite to the forward direction of the vehicle, when deployed.

20-21. (canceled)

22. A system as claimed in claim 1, wherein the mounted member and/or the additional energy absorbing structures provide at least one structure facing the expected point of initial impact from at least one side, to restrict sideways deflection of the other object, relative to the vehicle.

23. (canceled)

24. A system as claimed in claim 1, wherein the mounting arrangement provides resilient mounting of the mounted member, at least after being moved.

25. A system as claimed in claim 1, wherein the mounted member is able to absorb energy by non-resilient deformation.

26-27. (canceled)

28. A system as claimed in claim 1, further comprising:
at least one cushion member having a stowed condition and a deployed condition, and a container for the cushion member, when stowed,
the mounting arrangement being operable to move the container, relative to the vehicle, when deployment of the cushion member is required, to position the container adjacent a surface of the vehicle, to cause the cushion member to extend across the surface as it deploys.

29-30. (canceled)

31. A system as claimed in claim 28, wherein the mounting arrangement is operable to move the container prior to deployment.

32-39. (canceled)

40. A safety system for a vehicle, comprising:
at least one cushion member having a stowed condition and a deployed condition;
a container for the cushion member, when stowed;
a mounting arrangement which, in use, mounts the container on a vehicle;
a deployment arrangement which is operable to move the container, relative to the vehicle, when deployment of the cushion member is required, and to deploy the cushion member from the container;
the deployment arrangement being operable to position the container adjacent a surface of the vehicle, to cause the cushion member to extend across the surface as it deploys.

41-47. (canceled)

48. A system as claimed in claim 40, wherein the deployment arrangement is operable to position the or each cushion member for deployment in a direction generally opposite to the forward direction of the vehicle.

49. A system as claimed in claim 40, wherein the deployment arrangement is operable to position the or each cushion member for deployment over a bonnet panel of the vehicle.

50. A system as claimed in claim 40, wherein the deployed cushion member or members channel another body, in the event of a collision, substantially to a rest position, relative to the vehicle, at a predetermined position relative to the vehicle.

51-53. (canceled)

54. A safety system for a vehicle, comprising:
at least one member having a stowed condition and a deployed condition in the event of a collision with another object, the deployed condition serving to channel the other object to a rest position, relative to the vehicle, at a predetermined position relative to the vehicle.

55-58. (canceled)

59. A system as claimed in claim 1, comprising at least one member having a stowed condition and a deployed position in the event of a collision with another object, the deployed position serving to channel the other object to a rest position, relative to the vehicle, at a predetermined position relative to the vehicle.
